(19) United States
(12) Patent Application Publication
(10) Pub. No.: US 2006/0082580 A1
(43) Pub. Date: Apr. 20, 2006

(54) Method and apparatus for triggering frame updates

(76) Inventors: Raymond Chow, Richmond (CA); Jimmy Kwok Lap Lai, Vancouver (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/958,841

(22) Filed: Oct. 5, 2004

(51) Int. Cl. G06T 1/00

(52) U.S. Cl. 345/501

(57) ABSTRACT

A method for refreshing a display panel is provided. The method commences with initiating an event through a host processor, the event associated with a panel refresh signal. The event is then completed. A panel refresh signal is then issued through a display controller in response to completing the event without interrupting the host processor. The display controller is in communication with the host processor. A display controller and a device are provided.

### CROSS REFERENCE TO RELATED APPLICATIONS

This application is related to U.S. Patent Publication No. 2002/0057265, filed on Oct. 23, 2001, and entitled “Display Driver, and Display Unit and Electronic Instrument Using the Same,” and U.S. Patent Publication No. 2002/0011998, filed on Jul. 25, 2001, and entitled “RAM-Incorporated Driver, and Display Unit and Electronic Equipment Using the Same.” The disclosures of these applications are incorporated herein by reference in their entirety for all purposes.

### BACKGROUND

1. Field of the Invention

This invention relates generally to computer systems and more particularly to a method and apparatus for refreshing a display panel.

2. Description of the Related Art

As the demands placed on a host processor for rendering images has increased, there has been a concerted effort to offload these demands from the host processor in order to avoid overwhelming the host processor. For example, graphics processors and graphics accelerators have been developed to relieve the host processor from certain graphics operations. Fundamental rendering functions, such as, line drawing, circle and polygon drawing and filling, and bit-block-transfer (BitBLT), can be performed by the graphics accelerator. Graphics processors can execute high speed register instructions for performing these basic functions to write graphical elements to a frame buffer, thereby offloading from the host processor performance of the hardware level instructions to fill or modify the frame buffer. However, even with the accelerators, the host processor still handles tasks, such as display screen refreshes and tasks generated by hardware interrupts from the graphics subsystem.

Further exacerbating the demands on the host processor is the multi-thread environment that many devices operate in, e.g., cell phones. In the multi-thread environment, it is difficult to determine when the host can refresh the display panel. The host processor must wait for each refresh to complete, which places a timing constraint on the host processor when other events that require the panel to refresh are also occurring in the multithread environment. These demands and constraints become especially burdensome for processors associated with handheld devices due to the limited computing resources available for these devices.

As a result, there is a need to solve the problems of the prior art to provide an apparatus and method to offload the panel refresh task from the host processor.

Broadly speaking, the present invention fills these needs by providing a method and apparatus for offloading the panel refresh task from the host processor. It should be appreciated that the present invention can be implemented in numerous ways, including as a method, a system, or a device. Several inventive embodiments of the present invention are described below.

In one embodiment, a method for refreshing a display panel is provided. The method commences with initiating an event through a host processor, the event associated with a panel refresh signal. The event is then completed. A panel refresh signal is then issued through a display controller in response to completing the event without interrupting the host processor. The display controller is in communication with the host processor.

In another embodiment, a display controller is provided. The display controller includes an image processing logic module configured to manipulate display data. The display controller also includes frame transfer circuitry in communication with the image processing logic module. The frame transfer circuitry is configured to trigger a panel refresh signal for a display panel in communication with the display controller. The panel refresh signal is triggered in response to a signal from the image processing logic module indicating a transition from a busy state to an idle state for the image processing logic module.

In yet another embodiment, a device capable of displaying image data is provided. The device includes a central processing unit (CPU) and a display controller in communication with the CPU. The display controller includes a plurality of image processing logic modules configured to manipulate display data and frame transfer circuitry in communication with the plurality of image processing logic modules. The frame transfer circuitry is configured to trigger a panel refresh signal for a display panel in communication with the display controller. The panel refresh signal is triggered in response to a signal from one of the plurality of image processing logic modules thereby indicating a transition from a busy state to an idle state for the corresponding one of the plurality of image processing logic modules. The device further includes a display panel having integrated random access memory (RAM).

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a simplified schematic diagram illustrating a device in which panel refreshes occur through a host central processing unit (CPU).

FIG. 2 is a simplified schematic diagram illustrating a device having a panel refresh generated without interrupting a host CPU in accordance with one embodiment of the invention.

FIG. 3 is a simplified schematic diagram providing more detail for a display controller configured to automatically trigger panel refreshes based upon a selectable event in accordance with one embodiment of the invention.

FIG. 4 is a flow chart diagram illustrating the method operations for refreshing a display panel while minimizing CPU overhead in accordance with one embodiment of the invention.

### DETAILED DESCRIPTION

An invention is described for an apparatus and method for offloading the panel refresh requirements from a host central processing unit (CPU) in order to free the CPU to perform other tasks. It will be obvious, however, to one skilled in the art, that the present invention may be practiced without some or all of these specific details. In other instances, well known process operations have not been described in detail in order not to unnecessarily obscure the present invention.

The embodiments of the present invention provide a method and device that offloads the panel refresh task from the host processor. Instead, a panel refresh, also referred to as a frame transfer, occurs in response to user selectable events. That is, once a pre-determined event completes, the panel refresh is triggered automatically, i.e., without the host processor being required to issue the panel refresh signal. In one embodiment, modules that operate on display data are associated with a busy/idle signal. Thus, once the busy signal transitions to an idle signal, indicating that the corresponding process is complete, a panel refresh signal is triggered. This feature may be implemented through the use of several register enable bits. In another embodiment, the enable bits are configured to specify if the panel refresh repeats after each occurrence of the event or just after the first occurrence of the event. In yet another embodiment, the enable bits may be configured to specify if a certain event is activated. Exemplary events include a resizer frame complete event, a 2-dimensional or 3-dimensional bit block transfer (BitBLT) complete event, a Joint Photographic Expert Group (JPEG)/YUV decode complete event, a Moving Picture Expert Group (MPEG) decode complete event, a generic interrupt event, a display buffer change event, etc. It should be appreciated that the previous event list is not meant to be limiting as other events associated with modules that manipulate display data and where the corresponding modules are associated with a signal that transitions from a busy state to an idle state when a process completes, may be incorporated into the scheme discussed herein.

In another embodiment, the automatic panel refresh technique is associated with a device having a display panel that incorporates random access memory (RAM). RAM integrated panels include a driver for driving a display panel, such as a liquid crystal display (LCD) panel, in addition to the RAM. Further information concerning RAM integrated panels may be found in U.S. Patent Application Publication No. 2002/0057265 and U.S. Patent Application Publication No. 2002/0011998.

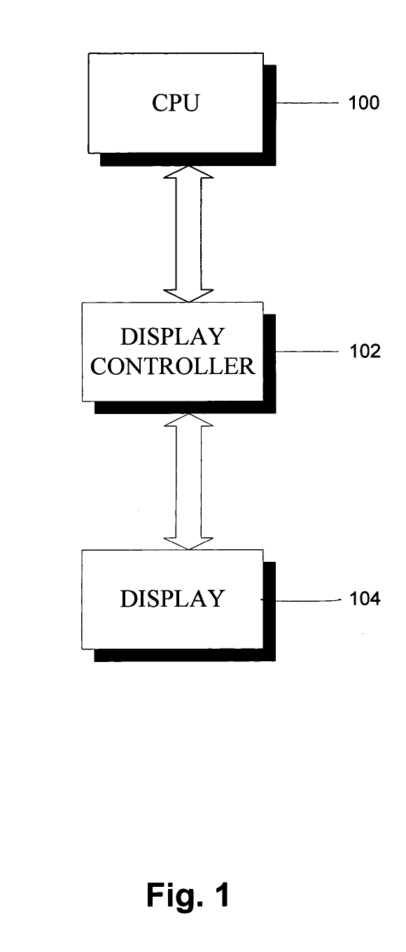

FIG. 1 is a simplified schematic diagram illustrating a device in which panel refreshes occur through a host central processing unit (CPU). The device includes CPU 100 in communication with display controller 102, which is in communication with display panel 104. Of course, display panel 104 may include embedded random access memory (RAM), where the display panel is a RAM integrated panel. Frame updates, also referred to as panel refreshes, may occur by host CPU 100 writing to a register bit to trigger the panel refresh. Alternatively, the panel refresh may be triggered by an enable bit for an auto frame transfer in response to a camera VSYNC signal. One skilled in the art will appreciate that RAM integrated panels have embedded memory which self-refreshes the display internally in the display 104 module. Thus, the panel refresh occurs as determined by host CPU 100.

As can be appreciated, when host CPU 100 is running in a multi-thread environment, it becomes difficult to determine when host CPU 100 can refresh the panel. The multiple processing occurring in the multi-thread environment may cause multiple panel refreshes, and in turn the host CPU 100 has to wait for each refresh to complete. This waiting places a time constraint on the host CPU since the refresh is tied to an external event.

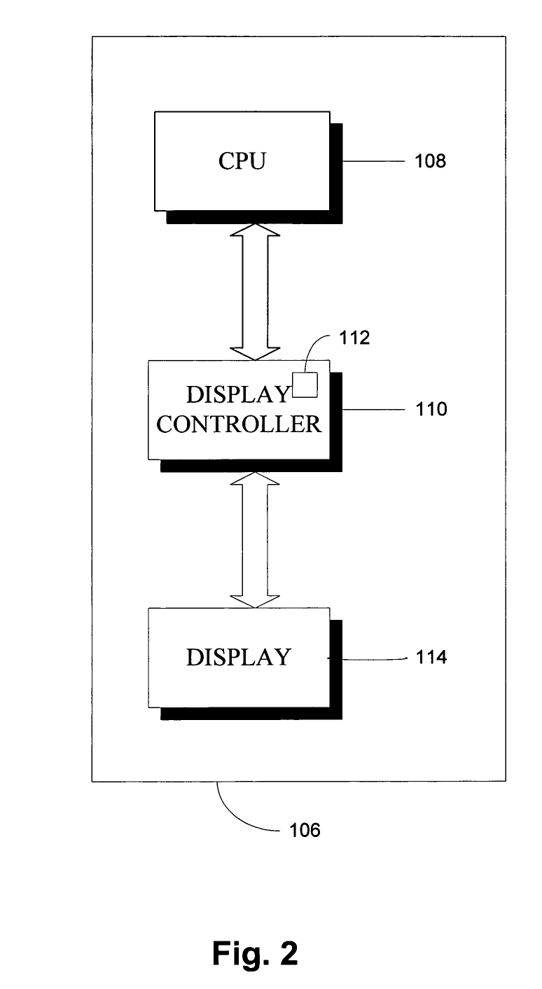

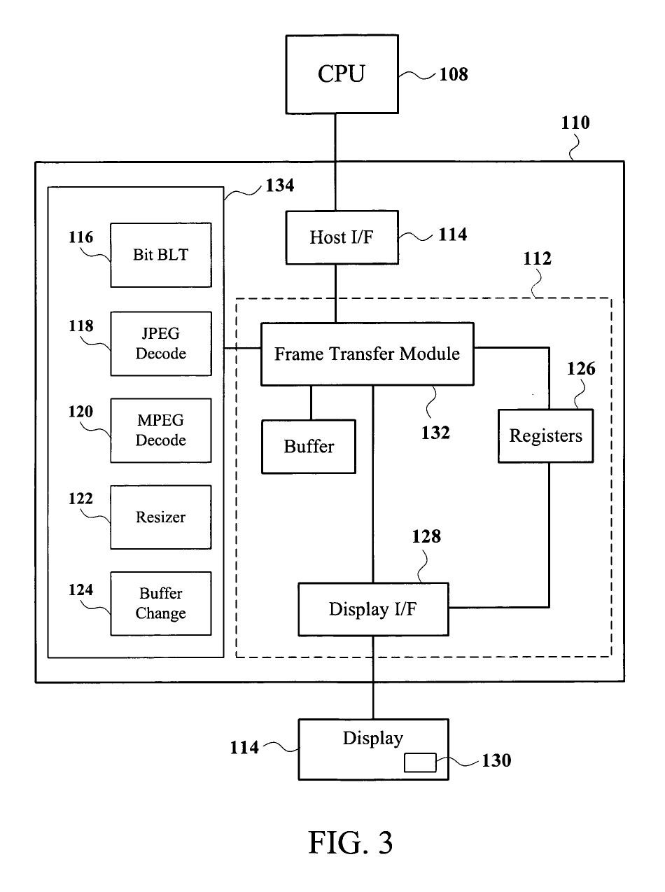

FIG. 2 is a simplified schematic diagram illustrating a device having a panel refresh generated without interrupting a host CPU in accordance with one embodiment of the invention. Device 106 includes CPU 108 in communication with display controller 110 which is in communication with display panel 114. Display controller 110 includes frame transfer circuitry 112. Frame transfer circuitry 112 enables the automatic triggering on the currents of user selectable events wherein those selectable events occur within display controller 110. Thus, as will be described in more detail below, this feature improves upon the existing method of frame transfers without adding additional CPU overhead. Consequently, CPU 108 is decoupled from updating the display that is synchronized on a future and asynchronous event. In one embodiment, display panel 114 includes RAM as illustrated with reference to FIG. 3.

FIG. 3 is a simplified schematic diagram providing more detail for a display controller configured to automatically trigger panel refreshes based upon a selectable event in accordance with one embodiment of the invention. CPU 108 is in communication with display controller 110 through host interface 114. Display controller 110 includes block 134, which contains a plurality of modules configured to manipulate display data. Each of the plurality of modules within block 134 may be used to trigger a panel refresh upon completion of the corresponding processing within the module. The modules of block 134 include BitBLT module 116, JPEG module 118, MPEG decode module 120, resizer module 122, and buffer change module 124. Of course, other modules may be incorporated into block 134. Each of the modules of block 134 is in communication with frame transfer module 132.

Still referring to FIG. 3, frame transfer module 132 is in communication with register block 126 and display interface 128. Display interface 128 communicates with display panel 114, where the display panel has RAM 130 integrated therein. Frame transfer module 132, register block 126, and display interface 128 are included within frame transfer circuitry 112. It should be appreciated that each of the modules within block 134 can toggle between a busy state and an idle state condition, i.e., any one of modules 116 through 124 may toggle from a busy state to an idle state. Toggling from a busy state to an idle state indicates that a process has been completed. The busy state/idle state is communicated to register block 126. The updated data from the corresponding module of block 134 may be transmitted to frame transfer module 132 that is connected to a frame buffer. Thus, the transition from a busy state to an idle condition may be used to trigger a panel refresh in order to update the display. It should be appreciated that a completion flag may be used to indicate the transition. Busy/idle state signals from all modules in block 134 are sent to Registers block 126, where there will be circuitry to detect the change from a busy state to an idle state for these signals. Then, according to the user programmed register setting, one or more of these signals will be OR-ed together to generate the panel refresh triggering signal.

Described below are three exemplary scenarios on triggering the frame transfer. In a first scenario the display interface is idle, i.e., no frame transfer is occurring to the panel. Here, the frame transfer trigger signal is issued and the display interface will detect the signal and execute a frame transfer to the panel. Under a second scenario, the display interface is busy, e.g., already executing a frame transfer. Here, the later frame transfer trigger is queued and will execute when the current frame transfer being executed is completed. Under a third scenario, the display interface is busy, e.g., already executing a frame transfer and a pending frame transfer is waiting in the queue. Here, another frame transfer trigger request, subsequent to the pending frame transfer trigger request, will be ignored. In summary, if a frame is being transferred and several requests to update the panel are received, only one of the requests is queued. When the display interface is completed, one additional frame transfer is executed, which will transfer the frame buffer contents with all of the cumulative display changes, rather than queuing a multiple triggers when the display interface is busy.

For example, with respect to resizer module 122, a resizer frame complete signal may automatically trigger a panel refresh based upon a frame transfer from the corresponding module to the frame buffer. For the resizer frame end, this event occurs when image data (typically from an asynchronous device such as a camera module or YUV input) passes through the resizer for cropping and/or scaling and has been processed. For example, if a 1,024×1,024 YUV stream is cropped to 320×240 and further scaled by a two-to-one, resulting in an output size after scaling of 160×120, the resizer operation ends on the 119^{th} line. In most cases, the resized data is meant for display on the panel. Thus, an LCD frame transfer would automatically occur synchronized with the external video source. If the image stream frame rate is fairly high, this saves several CPU cycles per frame for an interrupt service routine, which may be required to service a frame update.

With reference to a BitBLT module the event occurs after a CPU host has initiated a BitBLT operation and it has completed. One skilled in the art will appreciate that the CPU host is freed from having to detect the completion of the BitBLT operation, polling the display controller interface busy status to ensure the interface is not busy, and servicing the frame transfer to the panel. Thus, by triggering the panel refresh automatically based upon the frame transfer, the CPU host only has to initiate the BitBLT operation. That is, the frame transfer will occur on completion and will be synchronized with the BitBLT completion, which in turn, causes the status signal to transition from busy to idle.

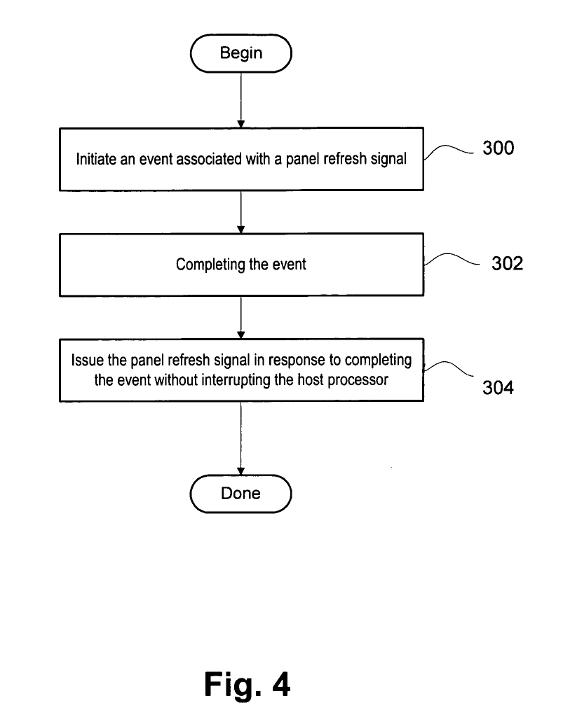

FIG. 4 is a flow chart diagram illustrating the method operations for refreshing a display panel while minimizing CPU overhead in accordance with one embodiment of the invention. The method initiates with operation 300 where an event associated with a panel refresh signal is initiated. Here, the event associated with the panel refresh signal may be any suitable event, such as the events listed above that manipulate display data and are processed within the modules of the display controller. The CPU initiates the event manipulating the display data. The method then advances to operation 302 where the event is completed within the module performing the operation. For example, a resize operation, BitBLT operation, JPEG decode, MPEG decode, a generic interrupt or a display buffer change may be completed within any of the modules described above. The method then proceeds to operation 304 where the panel refresh signal is issued in response to completing the event without interrupting the host processor. Thus, upon completion of the event, a panel refresh signal is triggered. Here, the change of a status signal from the corresponding module from a busy state to an idle state may be used to trigger the panel refresh signal. Alternatively, some means to signify the operation is completed, i.e., a Completion flag, may be used here.

In summary, the above-described embodiments enable the CPU to initiate a process that eventually requires a panel refresh, without having the CPU monitor completion of the process. Thus, once the CPU initiates the process, such as a BitBLT operation, a resize operation, etc., the CPU is assured that the frame transfer will occur upon the completion of the corresponding process and will be synchronized with the corresponding process. The embodiments described above may be incorporated into a handheld electronic device, such as, for example, a cellular phone, a web tablet, a personal digital assistant, a pocket personal computer, etc. The embodiments described herein can be used in any apparatus where a frame buffer needs to be transferred to another device with a frame buffer, e.g., a computing device having a RAM Integrated panel.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

The above-described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A method for refreshing a display panel, comprising method operations of:
initiating an event through a host processor, the event associated with a panel refresh signal;
completing the event; and
issuing the panel refresh signal through a display controller in response to completing the event without interrupting the host processor, wherein the display controller is in communication with the host processor.

2. The method of claim 1 wherein the event is selected from the group of events consisting of a resizer frame complete event, a BitBLT complete event, a Joint Photographic Expert Group (JPEG) decode complete event, a Moving Picture Expert Group complete event, and a Display Buffer change event.

3. The method of claim 1, wherein the method operation of completing the event includes,
transitioning a signal associated with the event from a busy state to an idle state.

4. The method of claim 1 wherein the display panel is a Random Access Memory (RAM) integrated display panel.

5. The method of claim 1, wherein the method operation of issuing the panel refresh signal through a display controller includes,
identifying that the panel refresh signal is a one time response to multiple occurrences of the event.

6. The method of claim 1, wherein the method operation of issuing the panel refresh signal through a display controller includes,
identifying that the panel refresh signal occurs in response to each occurrence of the event.

7. The method of claim 1, wherein the method operation of issuing the panel refresh signal through a display controller is synchronized with an external source providing display data for presentation on the display panel.

8. A display controller, comprising:
an image processing logic module configured to manipulate display data; and
frame transfer circuitry in communication with the image processing logic module, the frame transfer circuitry configured to trigger a panel refresh signal for a display panel in communication with the display controller, the panel refresh signal being triggered in response to a signal from the image processing logic module indicating a transition from a busy state to an idle state for the image processing logic module.

9. The display controller of claim 8, wherein the image processing logic module includes logic selected from the group consisting of logic for resizing the display data, logic for performing a bit block transform (BitBLT) operation, logic for decoding a Joint Photographic Expert Group file, and logic for decoding a Moving Picture Expert Group (MPEG) file.

10. The display controller of claim 8, wherein the frame transfer circuitry includes,
a frame transfer module in communication with the image processing logic module, the frame transfer module including memory to store the display data;
a register block receiving a status signal from the image processing logic module; and
a display interface configured to refresh a display panel based upon the status signal.

11. The display controller of claim 10, wherein the register block is configured to provide an enable bit to the display interface to trigger the panel refresh signal.

12. The display controller of claim 10, wherein the status signal indicates one of a busy state or an idle state.

13. The display controller of claim 12, wherein the transition of the status signal from the busy state to the idle state causes the register block to transmit an enable bit triggering the panel refresh signal.

14. A device capable of displaying image data, comprising:
a central processing unit (CPU);
a display controller in communication with the CPU, the display controller including,
a plurality of image processing logic modules configured to manipulate display data; and
frame transfer circuitry in communication with the plurality of image processing logic modules, the frame transfer circuitry configured to trigger a panel refresh signal for a display panel in communication with the display controller, the panel refresh signal being triggered in response to a signal from one of the plurality of image processing logic modules thereby indicating a transition from a busy state to an idle state for the corresponding one of the plurality of image processing logic modules; and
a display panel having integrated random access memory (RAM).

15. The device of claim 14, further comprising:
an image capture device configured to provide the display data.

16. The device of claim 14, wherein the frame transfer circuitry includes,
a register block receiving the signal from one of the plurality of image processing logic modules indicating the transition from the busy state to the idle state, the register block providing an enable signal in response to the transition to cause a panel refresh.

17. The device of claim 16, wherein the frame transfer circuitry includes,
a display interface through which the panel refresh signal passes to the display panel.

18. The device of claim 14, wherein one of the plurality of the image processing logic modules is configured to trigger the panel refresh after a number of predefined frame buffer writes have occurred.

19. The device of claim 14, wherein the plurality of the image processing logic modules includes logic modules selected from the group consisting of a logic module for resizing the display data, a logic module for performing a bit block transform (BitBLT) operation, a logic module for decoding a Joint Photographic Expert Group file, and a logic module for decoding a Moving Picture Expert Group (MPEG) file.
